(19) United States
(12) Patent Application Publication
(10) Pub. No.: US 2018/0365400 A1
(43) Pub. Date: Dec. 20, 2018

(54) BIOMETRIC AUTHENTICATION FOR CONNECTED VEHICLES INCLUDING AUTONOMOUS VEHICLES

(71) Applicants: Brennan T. Lopez-Hinojosa, Albuquerque, NM (US); Kermit D. Lopez, Albuquerque, NM (US)

(72) Inventors: Brennan T. Lopez-Hinojosa, Albuquerque, NM (US); Kermit D. Lopez, Albuquerque, NM (US)

(21) Appl. No.: 15/705,668

(22) Filed: Sep. 15, 2017

Related U.S. Application Data
(60) Provisional application No. 62/521,747, filed on Jun. 19, 2017.

(51) Int. Cl. G06F 21/32; B60W 50/08; G05D 1/00; B60R 25/25; G06K 9/00; H04W 12/06; G06Q 50/30; G08G 1/0967

(52) U.S. Cl. CPC G06F 21/32; B60W 50/08; G05D 1/0088; B60R 25/252; B60R 25/255; B60R 2011/0035; G06K 9/00832; H04W 12/06; G06Q 50/30; G08G 1/096725; B60R 25/257

(57) ABSTRACT

A biometric authorization apparatus and method for a vehicle. A visor is connected to an interior cabin of a vehicle, and a biometric authentication interface is associated with the visor. The biometric authentication interface includes one or more biometric readers for scanning the biometric identifier(s) provided by a user. The biometric authentication interface facilitates analysis and processing of data associated with the biometric identifier(s) for use in authorizing the user with respect to the vehicle and optionally to also access an electronic system associated with the vehicle. The vehicle can be, for example, an autonomous vehicle and the user may be a passenger of the autonomous vehicle or in the case of a connected vehicle, a driver or a passenger. In some situations, the vehicle may be a rideshare vehicle and the user may be authorized (or not) for a rideshare trip in the vehicle.

### CROSS-REFERENCE TO PROVISIONAL APPLICATION

This nonprovisional patent application claims the benefit under 35 U.S.C. § 119(e) and priority to U.S. Provisional Patent Application Ser. No. 62/521,747 filed on Jun. 19, 2017, entitled “Biometric Authentication for Connected Vehicles Including Autonomous Vehicles,” which is hereby incorporated herein by reference in its entirety.

### TECHNICAL FIELD

Embodiments are generally related to the field of smart vehicles including connected vehicles and autonomous vehicles. Embodiments also relate to biometric authentication/authorization for vehicle passengers and/or drivers through the use of biometric identifiers.

### BACKGROUND

With the rapid increase in wireless network resources, automobile manufacturers are working towards a connected vehicle that takes advantage of high network data speed to provide users with various services, such as, voice-controlled applications, infotainment, and/or diagnostics. Connected vehicles can be coupled to the Internet via network devices of most any communication network (e.g., cellular network, WiFi network, satellite communication network, etc.). Further, connected vehicles or connected cars can be directly coupled to each other via RF (Radio Frequency) wireless communications and other peer-to-peer communication technology.

Connected cars can include various communication devices, such as, devices embedded within the car and/or user equipment of the driver and/or passengers within the car. These devices have substantial computing power and independent communication (wireless) data links that couple the respective devices to the communication network.

In addition to advances in the connected vehicle or connected car area, automobile manufacturers are also developing so-called self-driving or autonomous vehicles.

Such connected vehicles and self-driving or autonomous vehicles will require some mechanism for authorizing a user (e.g., driver or passenger) access to the vehicle an for electronic systems associated with the vehicle.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for biometric authentication and control for connected vehicles and autonomous vehicles.

It is another aspect of the disclosed embodiments to authorize or authenticate a user through biometric authentication or authorization for access to a vehicle electronic system or vehicle electronic device.

It is yet another aspect of the disclosed embodiments to confirm or authorize a rideshare passenger for a rideshare trip through the use of biometric authorization/authentication.

It is a further aspect of the disclosed embodiments to provide a biometric authentication interface integrated or disposed on a visor attached to a vehicle cabin for use in authorizing a user with one or more biometric identifiers.

The aforementioned aspects and other objectives and advantages can now he achieved as described herein. In an example embodiment, a biometric authorization apparatus for a vehicle can be implemented. Such an apparatus can include a visor connected to an interior cabin of a vehicle; and a biometric authentication interface associated with the visor, wherein the biometric authentication interface comprises at least one biometric reader for scanning at least one biometric identifier provided by a user, wherein the biometric authentication interface facilitates analysis and processing of data associated with the at least one biometric identifier for use in authorizing the user with respect to the vehicle and/or to access an electronic system associated with the vehicle. The vehicle can be, for example, an autonomous vehicle and the user may be a passenger of the autonomous vehicle or in the case of a connected vehicle, a driver or a passenger.

In some example embodiments, the biometric authentication interface is integrated with the visor and the visor comprises an electronic device including the biometric authentication interface. In other example embodiments, the biometric authentication interface includes a display that functions both as the biometric reader and as a display for graphically displaying an interactive GUI (Graphical User Interface) that displays data for the user. The display can be, for example, a liquid crystal display (LCD), a thin film transistor-liquid crystal display (TFT-LCD), an organic light emitting diode (OLED), a flexible display, a 3-dimensional (3D) display, an e-ink display, and combinations thereof.

The biometric identifier can be, for example, one or more distinctive measurable characteristic associated with the user, such as a fingerprint, palm veins, facial recognition, DNA, palm print, hand geometry, iris recognition, retinal scan, and/or odor or scent associated with the user. The biometric reader can be, for example, a fingerprint scanner, an iris scanner, a retinal scanner, a voice recognition apparatus, and so on.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the, principles of the present invention.

FIG. 1 illustrates a pictorial diagram of a vehicle sun visor equipped with a biometric authentication interface, in accordance with an example embodiment;

FIG. 2 illustrates a pictorial diagram of a vehicle sun visor equipped with a biometric authentication interface, in accordance with another example embodiment;

FIG. 3 illustrates a functional block diagram depicting an environment, in accordance with one example embodiment;

FIG. 4 illustrates a block diagram of internal and external components of a computer system, which is representative the computer systems of FIG. 3, in accordance with an embodiment;

FIG. 5 illustrates a block diagram of a sun visor device having a biometric authentication interface and a biometric reader for use with a vehicle, in accordance with an example embodiment;

FIG. 6 illustrates a block diagram of a sun visor device having a biometric authentication interface and a biometric reader for use with a vehicle and which communicates with a processor, in accordance with an example embodiment;

FIG. 7 illustrates a block diagram of a sun visor device having a biometric authentication interface and a biometric reader for use with a vehicle, in accordance with another example embodiment;

FIG. 8 illustrates a block diagram of a sun visor device having a biometric authentication interface and a biometric reader for use with a vehicle and which communicates with a process through a network, in accordance with another example embodiment;

FIG. 9 illustrates a block diagram of a sun visor device having a biometric authentication interface and a biometric reader for use with a vehicle, in accordance with an example embodiment;

FIG. 10 illustrates a block diagram of a sun visor device having a biometric authentication interface and a biometric reader for use with a vehicle and which communicates with a processor, in accordance with an example embodiment;

FIG. 11 illustrates a block diagram of a sun visor device having a biometric authentication interface and a biometric reader for use with a vehicle, in accordance with another example embodiment;

FIG. 12 illustrates a block diagram of a sun visor device having a biometric authentication interface and a biometric reader for use with a vehicle and which communicates with a process through a network, in accordance with another example embodiment;

FIG. 13 illustrates a pictorial diagram of a display of a biometric authentication interface, in accordance with an example embodiment;

FIG. 14A illustrates a pictorial diagram of a biometric authentication interface implemented as a simple biometric reader, in accordance with an example embodiment;

FIG. 14B illustrates a pictorial diagram of a biometric authentication interface implemented as a simple biometric reader located on or integrated with a vehicle gear stick, in accordance with an example embodiment;

FIG. 15 illustrates a high level flow chart of operations depicting logical operations of a method for authorizing a user access to vehicle electronic system or device through a visor based biometric authentication interface, in accordance with an example embodiment; and

FIG. 16 illustrates a high level flow chart of operations depicting logical operations of a method for authorizing a user for a ride sharing through the visor based biometric authentication interface discussed herein, in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

A biometric authorization apparatus and method for a vehicle are disclosed herein. A visor is connected to an interior cabin of a vehicle, and a biometric authentication interface is associated with the visor. The biometric authentication interface includes one or more biometric readers for scanning the biometric identifier(s) provided by a user. The biometric authentication interface facilitates analysis and processing of data associated with the biometric identifier(s) for use in authorizing the user with respect to the vehicle and optionally to also access an electronic system associated with the vehicle. The vehicle can be, for example, an autonomous vehicle and the user may be a passenger of the autonomous vehicle or in the case of a connected vehicle, a driver or a passenger. In some situations, the vehicle may be a rideshare vehicle and the user may be authorized (or not) for a rideshare trip in the vehicle.

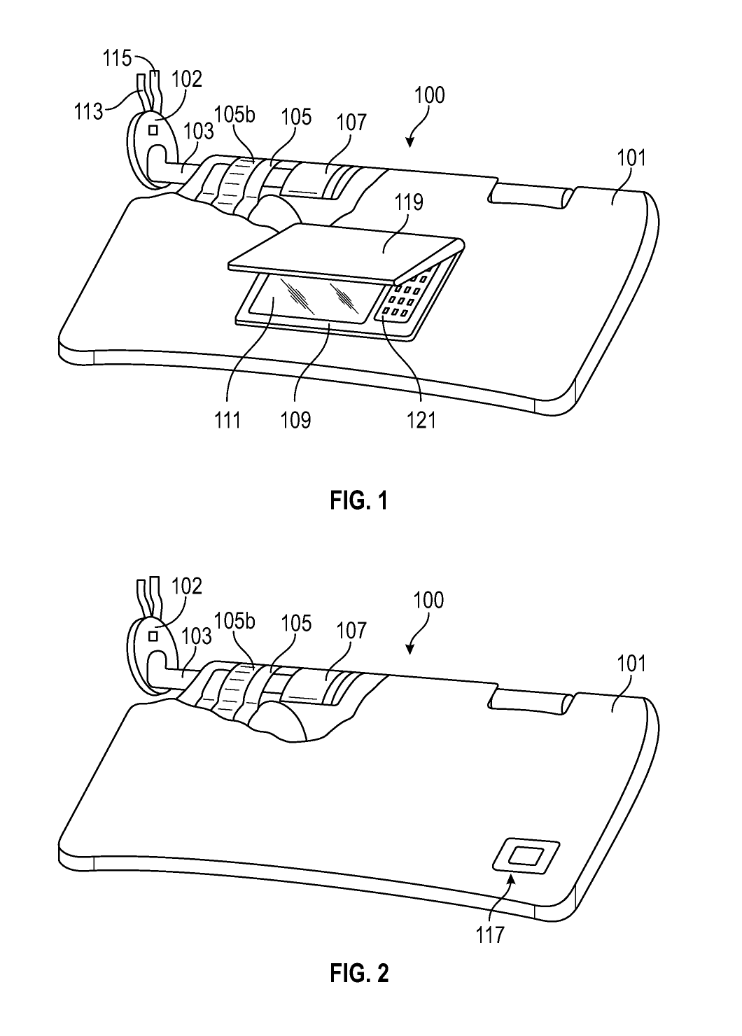

FIG. 1 illustrates a pictorial diagram of a vehicle sun visor 100 equipped with a biometric authentication interface 109, in accordance with an example embodiment. The vehicle sun visor 100 shown in FIG. 1 includes a sun visor body 101 and a support shaft 103 connected to a ceiling surface of a cabin (i.e., vehicle cabin) of a vehicle by a bracket 102. The sun visor body 101 can be configured to be turnable around the axis of the support shaft 103 between a storage position at which the sun visor body 101 is oriented along the ceiling surface of the vehicle cabin and a use, position at which the sun visor body 101 is able to block light.

In some example embodiments, the biometric authentication interface 109 can comprise any type of system/device configured to monitor and identify a user based, on one or more characteristics of the user. In one such configuration, a camera is capable of capturing a user's picture, such as of their face, and the biometric authentic interface 109 can compare the user's picture to a database containing data indicative of faces of a number of individuals or of known users. In other example embodiments, as discussed herein, the biometric authentication interface 109 may capture a user's fingerprint, retina scan, facial scan, iris scan (i.e., iris recognition), voiceprint (e.g., voice recognition), and so on. The biometric authentication interface 109 can include a movable lid that rotates up to open and down to close and which protects a display panel or display 111 of the biometric authentication interface 109.

A bearing portion 105 for the support shaft 103 is provided inside the sun visor body 101, and a leaf spring 105b that radially sandwiches the support shaft 103 is set at the bearing portion 105. The leaf spring 105b can be configured to be able to hold the sun visor body 101 at the shading position and, when the sun visor body 101 is returned to near the storage position, to apply turning force toward the storage position. Therefore, when the sun visor body 101 is located near the storage position, the sun visor body 101 is returned to the storage position by the spring force of the leaf spring 105b and is held at the storage position.

The sun visor 100 shown in FIG. 1 can serve two purposes. First, the vehicle sun visor 100 can be configured to move between a storage position at which the sun visor body 101 is oriented along the ceiling surface of a vehicle cabin and a use position at which the sun visor body 101 is able to block light. Second, the sun visor 100 can be equipped with a biometric authentication interface 109 that includes a display area for inputting or receiving one or more biometric identifiers (e.g., a biometric iris scan, face recognition, a fingerprint, voice recognition, and so on). The sun visor 100 and its electronic components such as the biometric authentication interface 109 may be powered via electronic leads or electronic connections 113, 115 which also can provide electrical/electronic signals and communication to and from the biometric authentication interface 109. Although a wired embodiment is shown in FIG. 1, it can be appreciated that wireless embodiments may also be implemented in which the biometric authentication interface communicates wirelessly with other electronic devices through wireless communications.

Note that the sun visor 100 may be a sun visor located in the front seat area of a vehicle (e.g., front driver seat or front passenger seat) or may be located in a rear seating area of a vehicle, for example, in a rear seat and located proximate to a window or in another convenient location for a passenger. Although the sun visor 100 is shown herein as being in a generally rectangular shape, it can be appreciated that the sun visor 100 may be configured in a variety of shapes (e.g., square, diamond shaped, triangular, circular, oval, oblong, etc.) and in different sizes. For example, in a rear passenger seat area, the sun visor may be located proximate to a passenger window and may be used to block out sunlight from all or substantially most of the window area.

In some example embodiments, the biometric authentication interface 109 can include a display unit or display panel 111 that also functions as a biometric reader. The display unit 111 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

In some example embodiments, the display unit 111 can be implemented using two display devices, which can implement the same or different display technology. In such an non-limiting example embodiment, a plurality of the display units may be arranged on one side, either spaced apart from each other, or these devices may be integrated, or these devices may be arranged on different surfaces. The display unit 111 may include a touch sensor which senses a touch input received at the display unit. When a touch is input to the display unit 111, the touch sensor may be configured to sense this touch and a controller (not shown in FIG. 1), for example, may generate a control command or other signal corresponding to the touch. The content which is input in the touching manner may be a text or numerical value, or a menu item which can be indicated or designated in various modes In some embodiments, the input may be, for example, a biometric input (e.g., fingerprint, retina, iris, etc.), and the sensor may function not merely as a touch sensor but also as a biometric sensor

The touch sensor embodiment may be configured in a form of a film having a touch pattern, disposed between the window and a display on a rear surface of the window, or a metal wire which is patterned directly on the rear surface of the window. Alternatively, the touch sensor may be integrally formed with the display. For example, the touch sensor may be disposed on a substrate of the display or within the display.

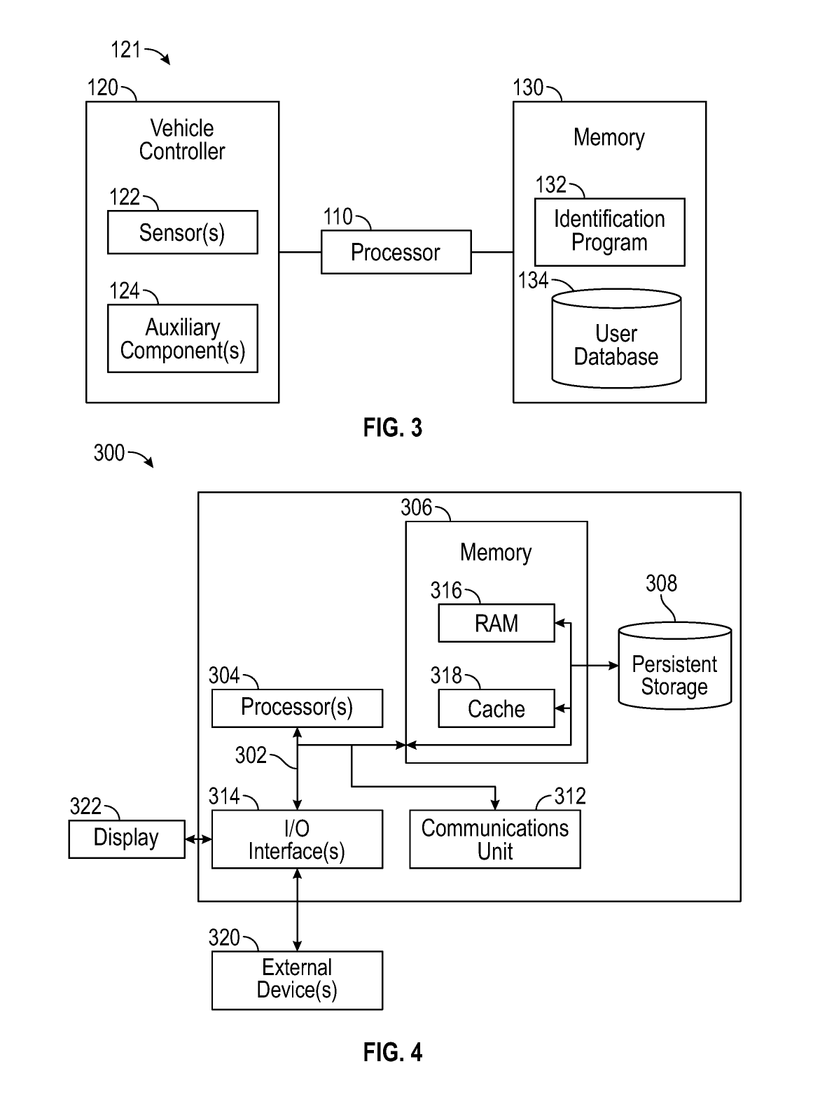

The display unit 111 may also form a touch screen together with the touch sensor. Here, the touch screen may serve as the user input unit (e.g., for inputting a biometric identifier). The aforementioned touch sensor may be, for example, a biometric sensor, or another type of sensor. Thus, in some example embodiments, the display unit 111 can function both as a GUI (Graphical User Interface) and a biometric reader or biometric sensor for obtaining biometric identifiers from a user, who may be, for example, a passenger or driver of a vehicle. Note that the aforementioned touch sensor or biometric sensor may be implemented as a sensor such as sensor(s) 122 illustrated and discussed herein with respect to FIG. 3.

The display unit 111 of the biometric authentication interface 109 can be implemented with a biometric reader or biometric sensor placed under the display unit's screen. For example, in some embodiments, a biometric sensor (e.g., a fingerprint sensor, retina sensor, iris sensor, etc.) can be slotted into a tiny space (e.g., 0.01-inch or 0.03 millimeter) cut into the underside of the cover glass of the display unit 111, allowing for the incorporation of biometric readers without dedicated buttons, pads, or other exposed elements.

In addition to the display unit 111, the biometric authentication interface 109 may also include a “hard” biometric reader 121 that may be implemented as a single biometric reader or may be implemented as a plurality of biometric readers for receiving and evaluating different types of biometric identifiers (e.g., fingerprints, retina, iris, voice recognition, etc.). In other words, the biometric reader 121 may be just a single type of biometric reader or may be implemented as one or more different types of biometric readers. In this situation, it may not be necessary to receive any biometric inputs through the display unit 111, and the display unit 111 may simply function as a Graphical User Interface (GUI) for receiving input or commands from a user and for displaying information for a user such as, for example, the current weather conditions, news, advertisements, and so on. In some embodiments, however, the biometric reader 121 may not be needed and all biometric identifiers may be input via the display 111, which is configured to receive biometric identifiers through the display 111.

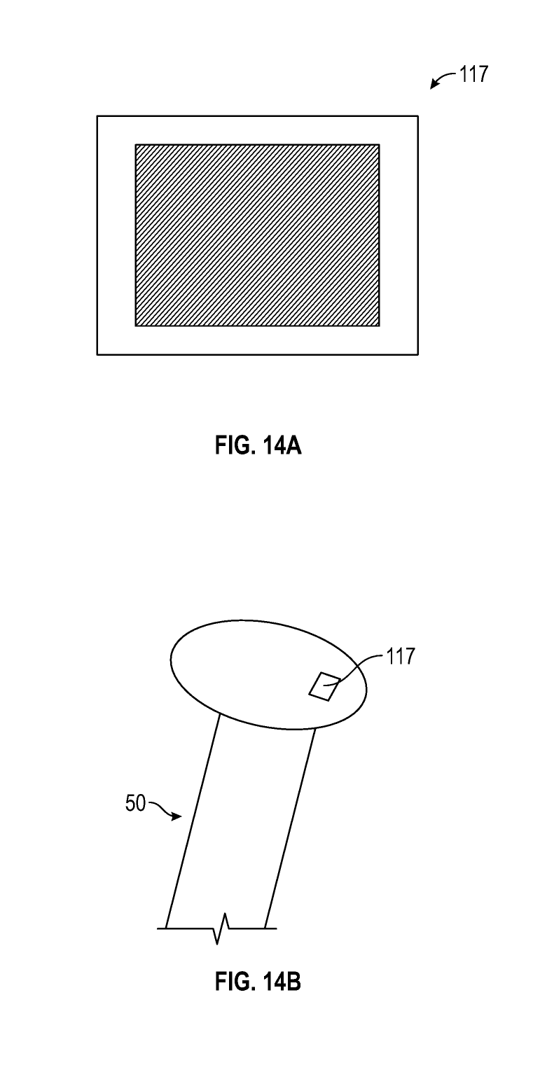

FIG. 2 illustrates a pictorial diagram of a vehicle sun visor 100 equipped with a biometric authentication interface 117, in accordance with another example embodiment. Note that in FIGS. 1-2, identical or similar parts or elements are generally indicated by identical reference numerals. The biometric authentication interface 117 shown in the example in FIG. 2 can be, for example, a biometric authentication interface that receives/scans biometric identifiers, such as an iris of a person, a fingerprint, voice recognition, fade recognition, and so on. The alternative example embodiment shown in FIG. 2 represents a simpler version of the various embodiment discussed above with respect to FIG. 1. That is, rather than offering a more sophisticated combined touch screen display and biometric sensing interface panel, a simple biometric sensor or biometric reader is shown in FIG. 2 in the context of a more basic biometric authentication interface 117. Note that although the biometric authentication interface 117 is shown in FIG. 2 as integrated with or connected to the visor 100, it can be appreciated that in alternative example embodiments, such a biometric authentication interface 117 can be located elsewhere in a vehicle. For example, the biometric authentication interface 117 may be located on a gear stick or level for a manual or automatic transmission in some example embodiments. This particular embodiment would be particularly useful in the context of a connected car or vehicle for a vehicle driver if implemented as a finger print or thumb biometric reader. FIG. 14B herein shows such an example embodiment.

Note that the terms biometric or biometrics as utilized herein refers to metrics, related to human characteristics. Biometrics authentication (or realistic authentication) can be used as a form of identification and access control with respect to a vehicle to which the vehicle sun visor 100 is attached. Biometric identifiers are distinctive, measurable characteristics used to label and describe individuals. Biometric identifiers may be categorized as physiological or behavioral characteristics. Physiological characteristics are related to the shape of the body. Examples include, but are not limited to fingerprint, palm veins, face recognition, DNA, palm print, hand geometry, iris recognition, retina, and odor/scent. Behavioral characteristics are related to the pattern of behavior of a person, including but not limited to, for example, typing rhythm and voice. In both FIG. 1 and FIG. 2, the biometric interfaces 109 and 117 are equipped with biometric sensors for detecting/identifying such biometric identifiers.

Biometrics as utilized herein thus involves measuring and analyzing of certain human physiological or behavioral characteristics for authentication or identification purposes using various instruments. Biometrics can be applied for both verification and identification purposes. Biometric verification verifies a person is who they claim to be, while biometric identification determines who the person is based on a measured biometric factor. There are many characteristics that can be used for biometric identification, such as, fingerprints, irises, voice patterns, facial geometry, DNA, etc.

Fingerprints are a common biometrics system, as it is generally accepted that fingerprints are unique to an individual. A person's actual fingerprints do not change throughout the life of the specific individual The primary dermal ridges form the actual pattern of the fingerprint unique to each individual. The fingerprint itself is static however the size and shape may vary with age.

Fingerprint recognition refers to an automated method of identifying or verifying the identity of an individual based on the comparison of two fingerprints. Specifically, fingerprint identification verifies the identity of a person by matching a fingerprint against a database of known fingerprints. In addition to one's identity, a fingerprint may also determine a person's general age and their gender based on a person's fingerprint ridge width. Thus, in some example embodiments, a biometric authentication interface such as interface 109 or 117 can include a capacitive fingerprint reader or an optical fingerprint reader. That is, in some example embodiments that include a fingerprint reader, the biometric interfaces 109 or 117 can provide a capacitive coupling or optical coupling (e.g., a light source configured to illuminate a fingerprint placed on the biometric interface 109 and a charge coupled device (“CCD”) to capture a digital image of the fingerprint) between the user and the biometric interface (e.g., a biometric reader). Examples of a biometric interface and/or a biometric authentication system are disclosed in U.S. Patent Application Publication No. 20150379255, entitled “Systems and Methods for Granting Access to a Computing Device Using a Wearable Device,” which is incorporated herein by reference in its entirety.

In some example embodiments, the biometric authentication interfaces 109 and/or 117 may implement biometric identification based on iris recognition or retinal scanning. Iris recognition is an automated method of biometric identification that uses mathematical pattern-recognition techniques on video images of one or both of the irises of an individual's eyes, whose complex patterns are unique, stable, and can be seen from some distance.

Retinal scanning is a different, ocular-based biometric technology that uses the unique patterns on a person's retina blood vessels and is often confused with iris recognition. Iris recognition uses video camera technology with subtle near infrared (IR) illumination to acquire images of the detail-rich, intricate structures of the iris which are visible externally. Digital templates encoded from these patterns by mathematical and statistical algorithms allow the identification of an individual or someone pretending to be that individual. A databases of enrolled templates can be searched by a matcher engine at speeds measured in the millions of templates per second per (single-core) CPU, and with remarkably low false match rates. Such a database of enrolled templates can be maintained in, for example, a memory such as the memory 308 discussed and illustrated in FIG. 4.

The biometric authentication interfaces 109 and/or 117 can thus include an iris scanner which can be embodied by way of components (e.g., combination of hardware, software and firmware) configured to apply mathematical pattern-recognition techniques on images of a single or both irises of the user of the biometric authentication interface 109 and/or 117. Such an iris scanner is capable of capturing high quality iris samples of user in form of complex random patterns that are unique, perceivable, and stable. In at least one example embodiment, the aforementioned iris scanner can include at least one infrared light emitting diode, for example, a light emitting diode (LED) and an infrared camera. The LED and infrared camera of the iris scanner may be arranged as a single module, or otherwise adjacent each other, or they may be arranged separate from each other and at a distance from each other within or on the sun visor 100 and/or the sun visor body 101.

The LED can be configured to illuminate the surrounding region of the one or both irises and the infrared camera is together with a processor (e.g., processor 110, processor(s) 304, etc., discussed herein) configured to generate high quality patterns of the one or both irises. In a non-limiting example, the aforementioned infrared camera may be a high resolution black and white camera with a field of view (FoV) between a range of, for example, 8 degrees to 28 degrees.

In an example embodiment, the aforementioned infrared camera can be synchronized with a camera module (a camera installed on the same side of the sun visor 100 and/or the sun visor body 101 where the infrared camera is installed) such that when the user adjusts his or her eyes in a field of view of the infrared camera with the help of viewfinder image frames generated by the camera module and displayed on a display screen associated with the biometric authentication interfaces 109 and/or 117; and the infrared camera can capture one or more iris shots of the user's iris. Herein and throughout the description, unless the context suggests otherwise, the term “user's iris” or simply “iris” represents one or both the irises of the user. Note that an example of a biometric iris recognition scanner is disclosed in U.S. Patent Application Publication No. 20170109511 entitled “Electronic Devices with Improved Iris Recognition and Methods thereof,” which is incorporated herein by reference in its entirety. Another example of a biometric recognition scanner and/or system is disclosed in U.S. Patent Application Publication No. 20160342836, entitled “Method and Apparatus for Power-Efficient Iris Recognition,” which is incorporated herein by reference in its entirety.

The biometric authentication interfaces 109 and 117 may be implemented as a unimodal biometric system or a multimodal biometric system. Multimodal biometric systems use multiple sensors or biometrics to overcome the limitations of unimodal biometric systems. For instance, iris recognition systems can be compromised by aging irises and finger scanning systems by worn-out or cut fingerprints. While unimodal biometric systems are limited by the integrity of their identifier, it is unlikely that several unimodal systems will suffer from identical limitations. Multimodal biometric systems can obtain sets of information from the same marker (i.e., multiple images of an iris or scans of the same finger) or information from different biometrics (requiring fingerprint scans and using voice recognition, a spoken pass-code, etc.). An example of a multimodal biometric authentication device and/or system is disclosed in U.S. Pat. No. 7,921,297, entitled “Random Biometric Authentication Utilizing Unique Biometric Signatures,” which is incorporated herein by reference in its entirety.

An example of a biometric authentication system is disclosed in U.S. Pat. No. 9,646,216, entitled “Multiple user biometric for authentication secured resources,” which is incorporated herein by reference in its entirety.

FIG. 3 illustrates a functional block diagram depicting an environment 121, in accordance with one example embodiment. FIG. 3 provides only an illustration of one example embodiment and does not imply any limitations with regard to the environments in which different embodiments may be implemented. Many modifications to the depicted environment may be made by those skilled in the art without departing from the scope of the disclosed embodiments, as recited by the claims.

Throughout this specification, environment 121 can be the inside of a vehicle, such as a car, sports utility vehicle, minivan, and truck. However, environment 121 is not limited to vehicles; rather the term vehicles is considered to include in addition to the above airplanes, boats, buses, trains, blimps, helicopters, etc. In the depicted example embodiment, environment 121 can include a vehicle controller 120 and a memory 130, interconnected by a processor 110.

The term “vehicle” as utilized herein includes connected vehicles and autonomous vehicles. A “connected vehicle” (e.g., a connected car) is a vehicle that is typically equipped with Internet access and also usually with a wireless LAN (Local Area Network). This allows the vehicle to share internet access with other devices both inside as well as outside the vehicle. Often, the vehicle is also outfitted with special technologies that tap into the internet or wireless LAN and provide additional benefits to the vehicle driver and/or passenger(s). One example of a connected vehicle is disclosed in U.S. Pat. No. 9,610,893, entitled “Methods and systems for providing alerts to a driver of a vehicle via condition detection and wireless communications,” which is incorporated herein by reference in its entirety.

An autonomous vehicle or autonomous car (also known as a driverless car, self-driving car, etc.) is a vehicle that is capable of sensing its environment and navigating without human input. Many such vehicles are being developed, but as of May 2017 automated cars permitted on public roads are not yet fully autonomous. They all require a human driver at the wheel who is ready at a moment's notice to take control of the vehicle. Autonomous cars use a variety of techniques to detect their surroundings, such as radar, LIDAR, laser light, GPS, odometer, and computer vision. Advanced control systems interpret sensory information to identify appropriate navigation paths, as well as obstacles and relevant signage. Autonomous cars have control systems that are capable of analyzing sensory data to distinguish between different cars on the road, which is very useful in planning a path to the desired destination.

A non-limiting example of an autonomous vehicle is disclosed in U.S. Pat. No. 9,630,616, entitled “Method for Controlling an Autonomous Vehicle System and Motor Vehicle,” which is incorporated herein by reference in its entirety. Another non-limiting example of an autonomous vehicle is disclosed in U.S. Patent Application Publication No. 20170132934, entitled “Software Application to Request and Control an Autonomous Vehicle Service,” which is also incorporated herein by reference in its entirety. Other non-limiting examples of autonomous vehicles are disclosed in U.S. Pat. No. 6,151.539, entitled “Autonomous vehicle arrangement and method for controlling an autonomous vehicle” describing necessary elements of autonomous driving vehicle; U.S. Pat. No. 9,475,491, entitled “Lane changing for autonomous vehicles” describing a method of changing travel lane of vehicle; U.S. Pat. No. 9,244,462, entitled “Vehicle trajectory planning for autonomous vehicles”; U.S. Pat. No. 9,428,163, entitled “Autonomous vehicle emergency braking method” claiming Emergency Braking of autonomous vehicle using collision mitigation electronic system; U.S. Pat. No. 8,139,109, entitled “Vision system for an autonomous vehicle” claiming a vision system of autonomous vehicle consisting of processors and cameras operating under different speed range; and U.S. Pat. No. 7,840.352, entitled “Method and system for autonomous vehicle navigation.” U.S. Pat. Nos. 6,151,539; 9,475,491; 9,244,462; 9,428,163; 8,139,109; and 7,840,352 are incorporated herein by reference in their entireties.

Thus, the term “vehicle” as utilized herein thus can include autonomous vehicles and connected, vehicles. In the case of an autonomous vehicle, the biometric authentication interfaces 109, 117 may be utilized to authorize a passenger access to a vehicle or particular vehicle systems or sub-subystems (e.g., entertainment, GPS, etc.) or simply to verify the person prior to the person (passenger) embarking on a ride in the vehicle.

The vehicle controller 120 can includes a sensor 122 and auxiliary component(s) 124. In this exemplary embodiment, the vehicle controller 120 allows the vehicle to start responsive to pushing a button. In this exemplary embodiment, the sensor 122 can be a biometric identification system for use in a vehicle and can be utilized or integrated with the biometric interfaces such as the biometric interfaces 109 and 117 shown in FIGS. 1 and 2. In other words, the biometric interfaces 109 are equipped with biometric sensors such as sensor 122. In some example embodiments, the sensor 122 is a biometric interface such as biometric authentication interface 109 or 117.

Sensor 122 can be configured as a sensor module capable of detecting various properties and characteristics of a driver or a passenger of a vehicle. Sensor 122 may be any sensor technology known in the art with the ability to acquire a biometric identifier such as, for example, a fingerprint, an iris, a retina, voice recognition, facial recognition, and so on. Thus, in some example embodiments, sensor 122 may be a fingerprint reader. In other example embodiments, sensor 122 can be a biometric iris scanner. In still other example embodiments, the sensor 122 (i.e., a biometric sensor) can be a retina scanner, etc. In some example embodiments, sensor 122 may be configured to scan and/or identify multiple and different types of biometric identifiers.

For example, sensor 122 may include an optical reader, a capacitive reader, an ultrasound reader, a thermal reader, etc. In one embodiment, sensor 122 is an optical reader, and takes a visual image of a fingerprint. In another embodiment, sensor 122 is a capacitive reader and utilizes capacitors to create an electrical current, based on the actual user's finger. In yet another embodiment, sensor 122 is an ultrasound reader and transmits a high frequency sound wave to penetrate the epidermal layer of the skin, thereby eliminating any cuts or scars on one's skin to acquire an accurate reading. In another embodiment, sensor 122 is a thermal reader and is highly sensitive to determine temperature differences between the ridges that make up one's fingerprint. Alternative embodiments of a fingerprint reader known in the art can be utilized as sensor 122.

Alternatively, sensor 122 may be any sensor technology known in the art with the ability to acquire biometric identification of the user. There are many additional characteristics that can be used for biometric identification, such as, irises, voice patterns, facial geometry, DNA, etc.

In an exemplary embodiment, sensor 122 can be installed in the visor vehicle sun visor 100 and coupled to vehicle controller 120. Additionally, sensor 122 may be installed in the visor and configured to communicate within the engine start button for both starting the vehicle by pushing a button as well as scanning the user's biometric identifier, or alternatively, in response to such a scan, the vehicle may then start automatically without pressing the engine start button.

Auxiliary component(s) 124 can include various peripheral elements associated with vehicle controller 120. Auxiliary component(s) 124 may include various systems which provide input and/or output to the identification program 132. In the exemplary embodiment, auxiliary component(s) 124 may include such peripheral items as a global positioning system (GPS), Bluetooth, satellite radio, etc. Alternatively, auxiliary component(s) 124 may not exist in an embodiment of the invention. Additional auxiliary component(s) 124 may be included by those skilled in the art.

Memory 130 includes identification program 132 and user database 134. Memory 130 may include any suitable volatile or non-volatile computer readable storage media and may include random access memory (RAM) and cache memory (not depicted in FIG. 1). Identification program 132 may be stored in a persistent storage component (not depicted) for execution and/or access by one or more of processor(s) 110 via one or more memories of memory 130. Alternatively, or in addition to a magnetic hard disk drive, the persistent storage component can include a solid state hard drive, a semiconductor storage device, read-only memory (ROM), erasable programmable read-only memory (EPROM), flash memory, or any other computer readable storage media that is capable of storing program instructions or digital information.

The Identification program 132 can analyze data from sensor 122, user database 134, and auxiliary component(s) 124, if equipped, to determine whether the driver is known as well as adjusts various vehicle settings. The identification program 132 can also analyze sensor 122 data and searches for a biometric match of the user. Specifically, the identification program 132 can evaluate biometric information to determine if the user (e.g., a driver or a passenger) is known to the vehicle, and/or in other contexts (e.g., previously authorized user with respect to the vehicle or with respect to the car ride itself). For example, identification program 132 can evaluate an image of a finger and/or other biometric identifiers to determine if the driver is known to the vehicle. The user's driver identification can be confirmed by comparing their biometric pattern (e.g., obtained via sensor 122) to patterns on record, within user database 134. The identification program 132 may derive, for example, the approximate age and gender of the user through the user's biometric information via sensor 122 and/or other information (e.g., a user profile associated with the user).

Additionally, the identification program 132 may draw on various features of auxiliary component(s) 124. For example, in one exemplary embodiment, if auxiliary component(s) 124 includes a GPS unit, it allows identification program 132 to learn the location of the vehicle as well as the posted speed limit for the street vehicle on. In another exemplary embodiment, if auxiliary component(s) 124 includes Bluetooth, then identification program 132, may automatically sync the drivers mobile phone to the vehicles Bluetooth even when other mobile phones are detected. Once the user's mobile phone is connected via Bluetooth, identification program 132 may utilize music playlists on mobile device and/or hands free capabilities if the user receives a phone call while operating the vehicle. Auxiliary component(s) 124 may also include a means to connect to a network, providing, identification program 132 with a larger database of potential user fingerprints.

User database 134 is a repository for data received from sensor 122 and vehicle settings. User database 134 can be implemented using any database architecture known in the art. User database 134 stores all information received from sensor 122 data as well as a users approximate age, known users preferred vehicle settings, and/or unknown user settings based on various age ranges. While depicted on memory 130 in FIG. 1, user database 134 may reside on a localized server, remote server, or a “cloud” of computers interconnected by one or more networks utilizing clustered computers and components to act as a single pool of seamless resources.

In an alternative example embodiment (not shown in environment 100), the user database 134 may be located on a server connected to sensor 122 over a network. The network may be implemented on a number of types of networks such as a local area network (LAN), an intranet, a wide area network (WAN), such as the Internet, a virtual local area network (VLAN), the public switched telephone network (PSTN), a mobile data network (e.g., wireless Internet provided by a third or fourth generation of mobile phone mobile communication), a private branch exchange (PBX), any combination thereof, or any combination of connections and protocols that will support communications between a server and sensor 122.

Reference is now made to FIG. 4. FIG. 4 illustrates a block diagram of internal and external components of a computer system 300, which is representative of the computer systems of FIG. 3, in accordance with an example embodiment. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (e.g., smartphones), multiprocessor systems, microprocessor-based systems, network PCs, minicomputer systems, mainframe computer systems, and distributed cloud computing environments that include any of the above systems or devices.

Computer system 300 includes a communications fabric 302, which provides for communications between one or more processors 304, memory 306, persistent storage 308, communications unit 312, and one or more input/output (I/O) interfaces 314. Communications fabric 302 can be implemented with any architecture designed for passing data and/or control information between processors (such as microprocessors, communications, and network processors, etc.), system memory, peripheral devices, and any other hardware components within a system. For example, communications fabric 302 can be implemented with one or more buses. Note that in some example embodiments, the processor(s) 304 shown in FIG. 4 and the processor 110 discussed previously with respect to FIG. 3 may actually be the same processor or processors.

Memory 306 and persistent storage 308 are computer readable storage media. In this embodiment, memory 306 includes random access memory (RAM) 316 and cache memory 318. In general, memory 306 can include any suitable volatile or non-volatile computer readable storage media. Software (e.g., identification program 132, etc.) is stored in persistent storage 308 for execution and/or access by one or more of the respective processors 304 via one or more memories of memory 306.

Persistent storage 308 may include, for example, a plurality of magnetic hard disk drives. Alternatively, or in addition to, magnetic hard disk drives, persistent storage 308 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 308 can also be removable. For example, a removable hard drive can be used for persistent storage 308. Other examples include optical and magnetic disks, thumb drives, and smart cards that are inserted into a drive for transfer onto another computer readable storage medium that is also part of persistent storage 308.

Communications unit 312 provides for communications with other computer systems or devices via a network (e.g., network 140). In this exemplary embodiment, communications unit 312 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to server through communications unit 312 (e.g., via the Internet, a local area network or other wide area network). From communications unit 312, the software and data can be loaded onto persistent storage 308.

One or more I/O interfaces 314 allow for input and output of data with other devices that may be connected to computer system 300. For example, I/O interface 314 can provide a connection to one or more external devices 320 such as a keyboard, computer mouse, touch screen, virtual keyboard, touch pad, pointing device, or other human interface devices. External devices 320 can also include portable computer readable storage media such as, for example, thumb drives, portable optical or magnetic disks, and memory cards. I/O interface 314 also connects to display 322.

Display 322 provides a mechanism to display data to a user and can be, for example, a computer monitor. Display 322 can also be an incorporated display and may function as a touch screen, such as a built-in display of a tablet computer.

Embodiments may be, for example, a system, a method, and/or a computer program product. The computer program product may include a computer readable storage medium (or media) having computer readable program instructions thereon for causing a processor to carry out aspects of the disclosed embodiments.

The computer readable storage medium can, be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that, perform the specified functions or acts or carry out combinations of special purpose hardware and computer instructions.

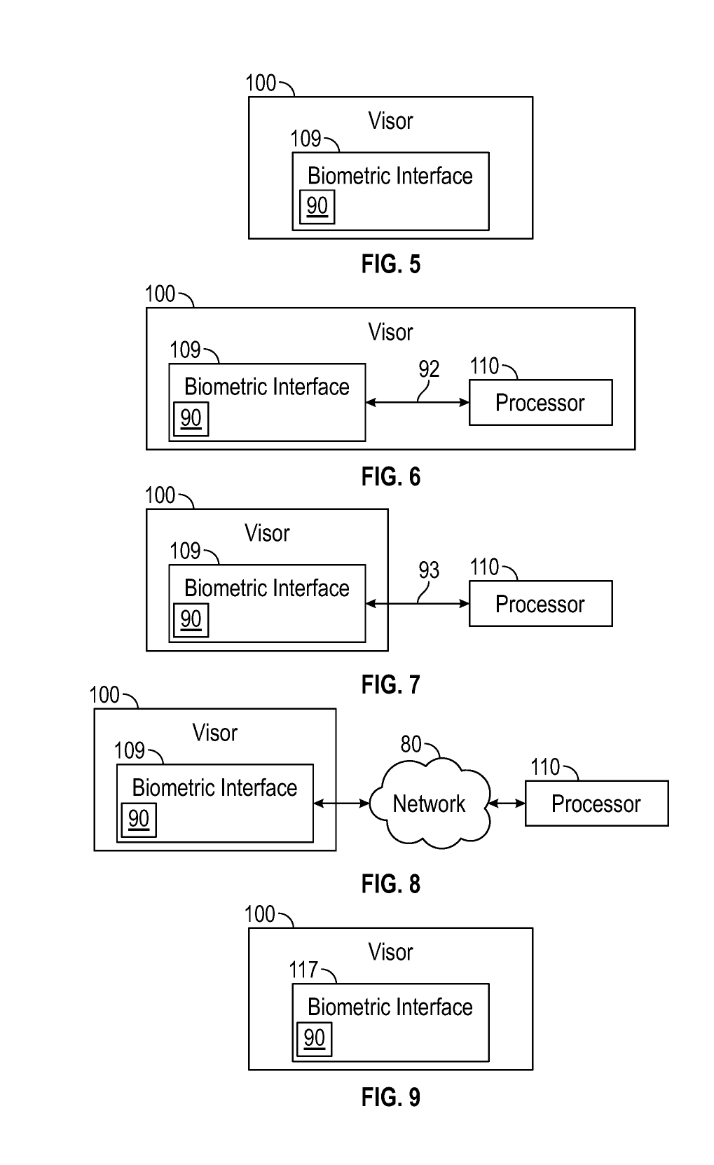

FIG. 5 illustrates a block diagram of the sun visor device 100 having the biometric authentication interface 109 and a biometric reader 90 (e.g., a biometric sensor) for use with a vehicle, in accordance with an example embodiment. Note that in FIGS. 5-12 and throughout the specification, identical or similar parts or elements are indicated by identical reference numerals. In the example embodiment depicted in FIG. 5, the sun visor or sun visor device 100 can be configured with the biometric authentication interface 109 incorporated into the sun visor 100. The biometric reader 90 can be conveniently located on the face of the sun visor 100 in a configuration in which a flip cover is opened to reveal the biometric authentication interface 109 which can also function as a display screen for displaying information for a user.

FIG. 6 illustrates a block diagram of the sun visor device 100 having the biometric authentication interface 109 and the biometric reader 90 for use with a vehicle and which communicates with a processor 110, in accordance with an example embodiment. The processor 110 may be configured with the visor 100 or the process 110 may be disposed in or with another electronic device or system or, for example, in the context of the system 100 shown in FIG. 1. Electronic/data communications between processor 110 and the biometric authentication interface 109 (which includes the biometric reader 90) is indicated by the bidirectional arrow 92 in FIG. 6.

FIG. 7 illustrates a block diagram of the sun visor device 100 having the biometric authentication interface 109 and the biometric reader 90 for use with a vehicle, in accordance with another example embodiment. In the example shown in FIG. 7, the processor 110 is shown external to the visor 100 and the biometric authentication interface 109. In the example embodiment shown in FIG. 7, the biometric authentication interface 109 can communicate with another device or system such as, for example, the system 121 shown in FIG. 3 (which includes the processor 110). In still other example embodiments, the biometric authentication interface 109 may communicate with the processor(s) 304 of system 300 shown in FIG. 4. Electronic/data communications between processor 110 and the biometric authentication interface 109 (which includes the biometric reader 90) is indicated by the bidirectional arrow 93 in FIG. 7.

FIG. 8 illustrates a block diagram of the sun visor device 100 having the biometric authentication interface 109 and the biometric reader 90 for use with a vehicle and which communicates with the processor through a network 80, in accordance with another example embodiment. In the embodiment shown in FIG. 8, the processor 110 can communicate with network 80 and the biometric authentication interface 109 also can communicate with network 80. Thus, processor 110 can communicate bidirectionally with the biometric authentication interface 109 through the network 80. Thus, network 80 may be a bidirectional data communications network, which may be wired or wireless, LAN, WAN, WiFi, cellular, satellite, or other means of establishing communication now known or to become known.

Network 80 can be enabled to employ any form of computer readable media for communicating information from one electronic device to another. Also, network 80 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Also, communication links within LANs typically include twisted wire pair or coaxial cable, while communication links between networks may utilize analog telephone lines, full or fractional dedicated digital lines including T1, T2, T3, and T4, Digital Signal level 3 (DS3), Optical Carrier 3 (OC3), OC12, OC48, Asynchronous Transfer Mode (ATM), Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 80 can be constructed for use with various communication protocols and technologies, including transmission control protocol/internet protocol (TCP/IP), user datagram protocol (UDP), a wireless application protocol (WAP), global system for mobile communications (GSM), code division multiple access (CDMA), time division multiple access (TDMA), general packet radio service (GPRS), ultra-wide band (UWB), IEEE 802.16 Worldwide Interoperability for Microwave Access (WiMax), and the like. In essence, network 80 includes any communication method by which information may travel between client devices and/or a server.

The visor 100 with its biometric authentication interface 109 (which includes the biometric reader 90) in this context function as a client device and the processor 110 may be a processor of, for example, a computer server. Such a client device may optionally communicate with a base station, or directly with another client device and may include a wireless interface that includes circuitry for coupling the client device to one or more wireless networks, and can be constructed for use with one or more communication protocols and technologies including, but not limited to, TCP/IP, UDP, GSM, CDMA, TDMA, SMS, CPRS, WAP, UWB, IEEE 802.16 (WiMax), and the like.

In some example embodiments, the network 80 may be a PAN (Personal Area Network), which may be enabled for Bluetooth wireless communications, induction wireless communications, infrared wireless communications, ultra-wideband wireless communications and/or ZigBee wireless communications. In some example embodiments, the wireless connection between the device 100 and the vehicle's radio system can be established via Secure Simple Pairing (SSP).

The network 80 may be implemented as a PAN (Bluetooth or otherwise) and the signal transmitted through the PAN. It should be appreciated that network 80 may be implemented not just via Bluetooth communications, but through one of a number of possible alternative PAN wireless technologies. For example, in one embodiment wireless network 80 may be implemented as a PAN based on induction wireless technology, which uses magnetic induction rather than radio for close-range communications. In radio, both electric and magnetic fields make up the signal, while in induction wireless, only the magnetic field is transmitted. The transmitter in this context is a radiating coil that is more like the primary winding of a transformer than an antenna. A PAN based on an induction wireless approach has about a 3-m range. A typical unit transmits up to 204.8-kbit/s data rates via GMSK modulation on 11.5 MHz. Key benefits of induction wireless technologies are extremely low power consumption, low cost, and the inherent security that accompanies short range.

Another implementation of network 80 can involve the use of infrared wireless communications. Such a PAN technology can be employed for use over short distances. The IrDA infrared (IR) standard appeared during the early 1990s and can be utilized to implement wireless network 85 as a PAN network. IrDA initially offered a 115.2-kbit/s data rate over a range of up to 1 m. A 4-Mbit/s version was soon developed and has been widely incorporated in laptops and PDAs for printer connections and short-range PANs. A 16-Mbit/s version is available, too.

The problem with IrDA is not just its very short range, but also its need for a line-of-sight (LOS) connection. Of course, Bluetooth does not need LOS and it can blast through walls. A more recent IR development is IrGate, which was produced by Infra-Com Technologies. This new IR development uses arrays of high-powered IR LEDs to emit coded baseband IR in all directions. Then, it relies on an array of photodetectors and super-sensitive receivers to pick up the diffused IR within the networking space. Thus,the LOS problem is mitigated and a data rate of up to 10 Mbit/s is possible.

Still another wireless technology for implementing wireless network 80 in the context of, for example, an in-vehicle PAN is UWB (Ultra-Wideband), which transmits data by way of baseband pulses applied directly to the antenna. The narrow pulses (less than 1 ns) create an extremely broad bandwidth signal. The pulses are modulated by pulse position modulation (PPM) or binary phase-shift keying (BPSK). The FCC permits UWB in the 3.1- to 10.6-GHz band. Its primary application to date has been short-range, high-resolution radar and imaging systems that penetrate walls, the ground, and the body. In addition, this new technology is useful for short-range LANs or PANs that require very high data rates (over 100 Mbits/s).

Still another wireless technology for implementing wireless network 80 in the context of, for example, an in-vehicle PAN is ZigBee, which is a simpler, slower lower-power, lower-cost cousin of Bluetooth, ZigBee. ZigBee is supported by a mix of companies that are targeting the consumer and industrial markets. It may be a better fit with games, consumer electronic equipment, and home-automation applications than Bluetooth. Short-range industrial telemetry and remote control are other target applications. It can be appreciated, however, that wireless network 80 can be implemented as a ZigBeen PAN.

Previously referred to as RF-Lite, ZigBee is similar to Bluetooth because it uses the 2.4-GHz band with frequency-hopping spread-spectrum with 25 hops spaced every 4 MHz. The basic data rate is 250 kbits/s, but a slower 28-kbit rate is useful for extended range and greater reliability. With a 20-dBm power level, ZigBee can achieve a range of up to 134 meters at 28 kbits/s. It additionally allows for networking of up to 254 nodes.

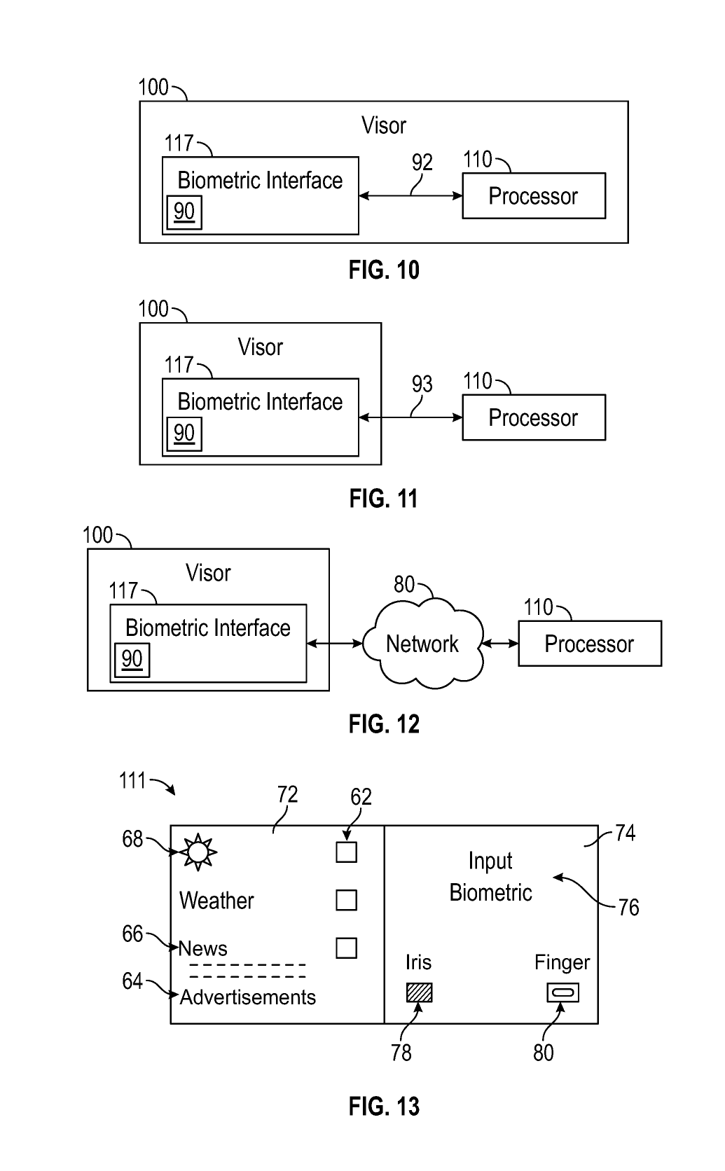

FIG. 9 illustrates a block diagram of the sun visor device 100 having the biometric authentication interface 117 and the biometric reader 90 for use with a vehicle, in accordance with an example embodiment. FIG. 10 illustrates a block diagram of the sun visor device 100 having the biometric authentication interface 117 and the biometric reader 90 for use with a vehicle and which communicates with the processor 110, in accordance with an example embodiment. FIG. 11 illustrates a block diagram of the sun visor device 100 having the biometric authentication interface 117 and the biometric reader 90 for use with a vehicle, and which communicates with the processor 110 (wherein the process is external to the visor 100), in accordance with another example embodiment.

FIG. 12 illustrates a block diagram of the sun visor device 100 having the biometric authentication interface 117 and the biometric reader 90 for use with a vehicle and which communicates with the processor 110 through the network 80, in accordance with another example embodiment.

FIG. 13 illustrates a pictorial diagram of the display 111 of the biometric authentication interface 109, in accordance with an example embodiment. The display 111 can be configured in the context of a GUI (Graphical User Interface) that graphically displays information in one or more display areas of the display 111 and which also provides graphical icons for inputting one or more biometric identifiers from a user. In the example shown in FIG. 13, two display areas 72 and 74 are shown although it can be appreciated that fewer or more display areas may be implemented in accordance with various alternative embodiments. In the display area 72, information such as current weather conditions 88, headlines or news 86, advertisements 64, and various other graphically displayed icons and graphics 62 may be displayed.

The display 111 may be a touch-sensitive display also referred to as a touchscreen. Such a touchscreen is an input and output device normally layered on the top of an electronic visual display of an information processing system. A user can give input or control the information processing system through simple or multi-touch gestures by touching the display panel or screen 111 with one or more fingers. The user can use the touchscreen to react to what is displayed and to control how it is displayed; for example, zooming to increase the text size.

Note that in some example embodiments, the display or touchscreen 111 may suffer the problem of fingerprints on the display, effectively making it difficult to obtain actual fingerprint biometrics or other biometric identifiers. This can be mitigated by the use of materials with optical coatings designed to reduce the visible effects of fingerprint oils, or oleophobic coatings, which lessen the actual amount of oil residue (which includes alcohol), or by installing a matte-finish anti-glare screen protector, which creates a slightly roughened surface that does not easily retain smudges.

Data such as video may also be displayed in the touchscreen 111 within display area 72 or display area 74. For example, a short video may be displayed in either the display area 72 or 74 with information including audio (e.g., the audio may be played through a speaker associated with the biometric authentication interface 109 and/or through the vehicle's radio system) prompting or instructing the user to enter his or her biometric identifier such as an iris through a graphically displayed iris scanner 78 and/or a fingerprint through a graphically displayed fingerprint scanner 80. A command 76 such as “Input Biometric” may also be displayed in the display area 74 above the graphically displayed biometric readers 78, 80. It can be appreciated that fewer or more graphically displayed biometric readers may be displayed within the display area 74 and/or that other types of biometric readers (e.g., retina scanner, voice recognition, etc.) may be deployed in the context of the display 111.

In some example embodiments, the lid 119 shown in FIG. 1 can also include a display or screen in addition to the screen 111. Thus, the embodiment shown in FIG. 1 can be implemented as a dual-touchscreen which uses two screens, either or both of which can be touch-capable, to display both elements of the GUI and virtual and virtualized implementations of common input devices, including, for example, virtual keyboards. Usually, in a dual-touchscreen computer or computing device, the most persistent GUI elements and functions are displayed on one, hand-accessible touchscreen (changing with the software application in use) alongside the virtual keyboard, while the other, more optically-centric display can be used for those user interface elements which are either less or never accessed by user-generated behaviors.

FIG. 14A illustrates a pictorial diagram of the a biometric authentication interface 117 implemented as a simple biometric reader, in accordance with an example embodiment. As discussed previously, such a biometric reader may be a fingerprint scanner, a retina scanner, an iris scanner, a small microphone that captures a person's voice for biometric voice recognition analysis, a facial scanner, and so on.

FIG. 14B illustrates a pictorial diagram of a biometric authentication interface 117 implemented as a simple biometric reader located on or integrated with a vehicle gear stick 50, in accordance with an example embodiment. In the example embodiment shown in FIG. 14B, the vehicle gear stick 50 includes the biometric authentication interface 117, which in a preferred example embodiment would be fingerprint or thumbprint biometric reader/scanner implementation. The gear stick 50 can be, for example, a gear stick also known as a gear lever, or a gearshift or shift, which is a lever attached to the shift assembly in a manual transmission-equipped automobile for use in changing gears. In an automatic transmission-equipped vehicle, the gear stick 50 is instead known as a gear selector. In some example embodiments, a vehicle driver would place his hand on the stick and in particular place his thumb or finger on the biometric authentication interface 117 to imitate a biometric authorization/authentication operation which would then allow the user access to start the vehicle or in some cases trigger automatic starting of the vehicle once a biometric match is made, as discussed herein. If a match is not made, then the vehicle will not start.

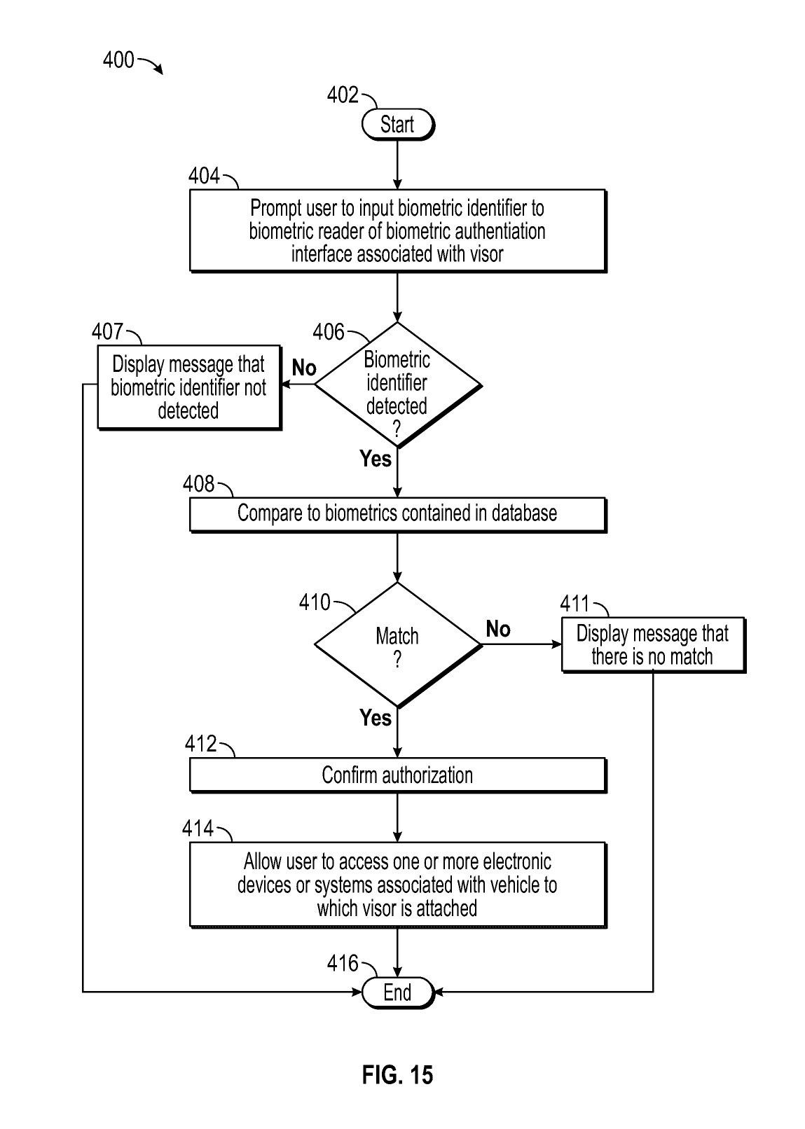

FIG. 15 illustrates a high level flow chart of operations depicting logical operations of a method 400 for authorizing a user access to vehicle electronic system or device through a visor based biometric authentication interface, in accordance with an example embodiment. Note that the various steps, operations, or instructions shown in FIG. 15 can be provided in the context of, for example, the identification program shown in FIG. 3. Additionally, the aforementioned vehicle electronic system or device may be a system such as, for example, the system 121 depicted in FIG. 3 or the system 300 shown in FIG. 4. In some examples, the vehicle electronic system may be a vehicle starting system or may be simply a vehicle based entertainment system or wireless network as discussed herein. In some cases, the vehicle electronic system may be a system associated with an autonomous vehicle.

As indicated a block 402, the process begins. Then, as shown at block 404, a step, operation, or instruction can be implemented in which the user is prompted to input his or her biometric identifier to a biometric reader or biometric sensor associated with, for example, the visor 100 discussed previously. A test can then be performed, as depicted at block 406, to determine if the biometric identifier has been detected. If a biometric identifier (or one or more identifiers) is detected, then, as indicated next at block 408, a step or operation can be implemented to compare the detected biometric identifier to biometric identifiers contained in a database such as in the user database 134 shown in FIG. 3. If the biometric identifier is not detected, then as indicated at block 407, a message can be displayed via a display such as, for example, the display area 72 or 74 shown in FIG. 13 indicating that the biometric identifier was not detected. The process can then terminate as shown at block 416.

Assuming there is a match found, as indicated by decision block 410, authorization of the user can be confirmed, as shown at block 412, and then as indicated at block 414, the user is allowed or granted access to one or more electronic devices or systems associated with the vehicle and to which the visor 100 is attached. The process can then terminate as indicated at block 416. If a match is not found, then as shown at block 411, a message can be displayed (e.g., via the display area 72 or 74) indicating that there is not a match, and the process can then end, as shown at block 416.

Note that the biometric identification/detection and matching operations depicted at blocks 406, 408, and 410 can be implemented through a variety of matching and classification techniques including the use of ML (Machine Learning). ML techniques can be employed in the context of, for example, an algorithm that operates by building a model from example inputs and used to make predictions or decisions rather than following strictly static program instructions. ML can be used to construct a model or rule set to predict a result based on values with respect to a number of features. A series of input patterns can be provided to an algorithm along with a desired output (e.g., the label) and the algorithm then learns how to classify the patterns by outing a desired label. In supervised learning (e.g., Kernal-based support vector machine (SVM) algorithm), a human operator must provide the labels during a teaching phase. Alternatively, unsupervised clustering is a process of assigning labels to the input patterns without the use of the human operator. Such unsupervised methods generally function through a statistical analysis of the input data by determining an Eigen value vector of a covariance matrix.

One non-limiting ML technique that can be adapted for use in accordance with an embodiment is disclosed in U.S. Pat. No. 8,429,103, entitled “Native Machine Learning Service for User Adaptation on a Mobile Platform,” which issued on Apr. 23, 2013 and is incorporated herein by reference in its entirety. It can be appreciated that such ML approaches are referred to for illustrative purposes only and are not considered limiting features of the disclosed embodiments.

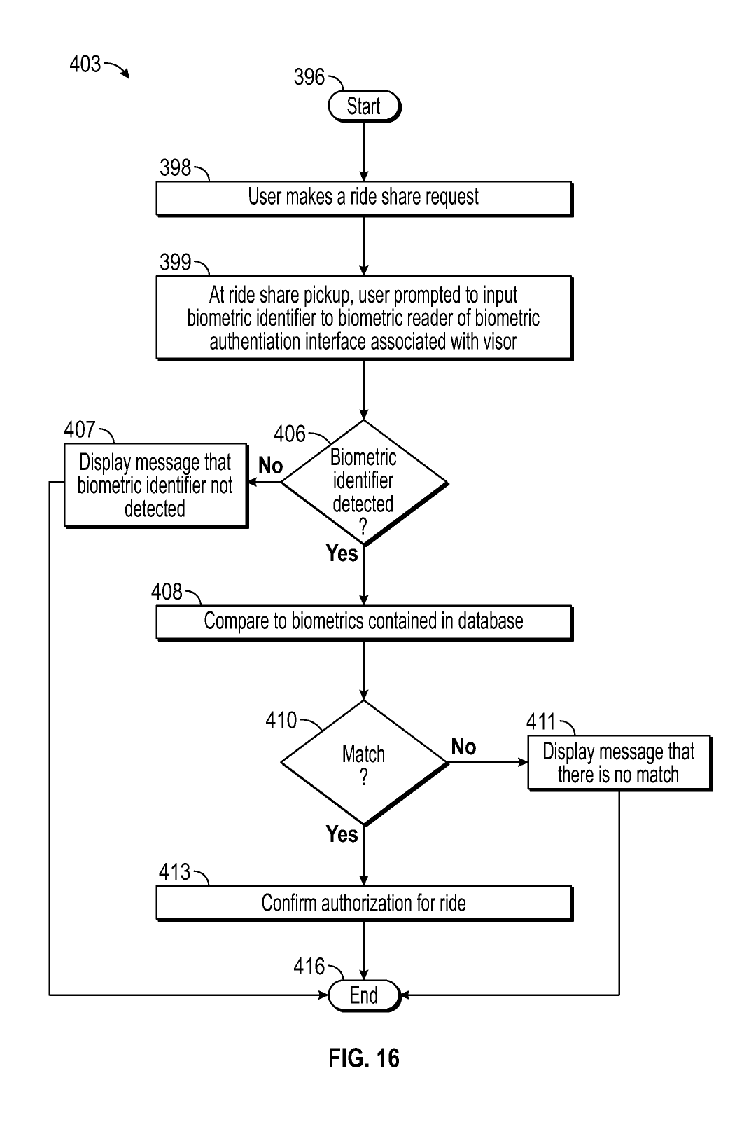

FIG. 16 illustrates a high level flow chart of operations depicting logical operations of a method 403 for authorizing a user for a ride sharing through the visor based biometric authentication interface discussed herein, in accordance with an example embodiment. Note that the method 403 is similar to the method 400 disclosed in. FIG. 15, but with some differences. Instead of being authorized via biometric authentication or authorization for access to an electronic system or device associated with the vehicle, the user can be authorized to participate in a rideshare. Thus, as shown at block 396, the process begins. Then, as indicated at block 398, the user can make a rideshare request for a rideshare trip, preferably through a ride sharing application such as, for example, UBER, LYFT, and so on.

Note that as utilized herein, the term rideshare or ride share refers to applications and business involving private individuals or agents that own vehicles serving as on-call transportation service providers that are linked to potential passengers or persons requesting delivery of packages via service provider organizations (“SPOs”). Examples of ride share entities that the term SPO term is meant to refer to include but are not limited to UBER, LYFT, and SIDECAR. The potential passengers/package owners are linked to the SPOs and drivers using GPS-enabled mobile computing devices, such as phones or tablets employing specific software. The embodiments disclosed herein can thus be adapted for use in identifying and authorizing a user for a rideshare trip, thereby providing a level of security and assurance to the rideshare driver and/or passenger.

The steps shown at blocks 406, 407, 408, 410, 411 and 416 are similar to the same steps operations shown in FIG. 15. A difference is that as indicated at block 413, following a successful matching operation (i.e., decision block 410), the user is authorized/confirmed for the rideshare trip or ride. Thus, the operations depicted in FIG. 16 can be utilized for the biometric authorization of a user for a rideshare application. In this case, a biometric authorization interface (associated with or without the visor) is connected to the interior cabin of a vehicle (or in some cases may be integrated into a user's seat). The biometric authentication interface comprises at least one biometric reader for scanning at least one biometric identifier provided by the user. The biometric authentication interface facilitates analysis and processing of data associated with the at least one biometric identifier for use in authorizing the user for a rideshare trip in the vehicle and can also be used in some example embodiments to authorize the user access to an electronic system associated with the vehicle during the rideshare trip. For example, the user may wish to have access to navigation information, entertainment data, and other features via the vehicle's electronic system during such a trip.

Based on the foregoing, it can be appreciated that a number of example embodiments are disclosed herein. For example, in one embodiment, a biometric authorization apparatus for a vehicle can be implemented, which includes a visor connected to an interior cabin of a vehicle; and a biometric authentication interface associated with the visor, wherein the biometric authentication interface comprises at least one biometric reader for scanning at least one biometric identifier provided by a user, wherein the biometric authentication interface facilitates analysis and processing of data associated with the at least one biometric identifier for use in authorizing the user with respect to the vehicle and/or to access an electronic system associated with the vehicle.

In some example embodiments, the biometric authentication interface can be integrated with the visor and the visor comprises an electronic device including the biometric authentication interface. In another example embodiment, the biometric authentication interface can include a display that functions both as the biometric reader and as a display for graphically displaying an interactive GUI (Graphical User Interface) that displays data for the user. In some example embodiments, the aforementioned display can, be, for example, a liquid crystal display (LCD), a thin film transistor-liquid crystal display (TFT-LCD), an organic light emitting diode (OLED), a flexible display, a 3-dimensional (3D) display, an e-ink display, and combinations thereof.

In another example embodiment, the at least one biometric identifier can be at least one distinctive measure characteristic associated with the user. The at least one biometric identifier can be, for example, a fingerprint, palm veins, facial recognition, DNA, palm print, hand geometry, iris recognition, retinal scan, and/or odor or scent associated with the user, and so on.

In some example embodiments, the at least one biometric reader can be a fingerprint scanner. In another example embodiment, the aforementioned fingerprint scanner can be a capacitive fingerprint reader. In yet another example embodiment, the aforementioned fingerprint scanner can be an optical fingerprint reader. In still another example embodiment, the at least one biometric reader can be an iris scanner. In another example embodiment, the at least one biometric reader may be a facial recognition apparatus comprising at least one camera (i.e., one or more cameras).

In some example embodiments, the at least one biometric reader can be an in scanner. In yet other example embodiments, the aforementioned iris scanner can include, for example, one or more infrared light emitting diodes and one or more IR (Infrared) cameras. In still another example embodiment, the at least one biometric reader can be a voice recognition device.

Note that in some example embodiments, the aforementioned “user” can be the driver of the vehicle or a vehicle passenger. In some example embodiments, the visor can be located in the front seat area of the vehicle and/or in a rear seat area of the vehicle. In some example embodiments, the aforementioned vehicle can be an autonomous vehicle and the user is preferably a passenger of the autonomous vehicle. In yet another example embodiment, the user may be a driver of a vehicle that is a “connected vehicle” but which functions as an autonomous vehicle only in certain cases (e.g., during an autonomous mode), in which case the driver would actually be more or less a passenger even if he or she is sitting in the driver's seat.

Note that in some example embodiments, the aforementioned display can be implemented as a touch-sensitive display covered by a protective cover that when opened activates an operation of the display. That is, the action of opening the cover activates power and electronics for the display.

In another example embodiment, a biometric authorization apparatus for a rideshare application can be implemented, which includes, for example, a biometric authentication interface connected to an interior cabin of a vehicle, wherein the biometric authentication interface comprises at least one biometric reader for scanning at least one biometric identifier provided by a user, wherein the biometric authentication interface facilitates analysis and processing of data associated with the at least one biometric identifier for use in authorizing the user for rideshare trip in the vehicle and access to an electronic system associated with the vehicle during the rideshare trip.

In still another example embodiment, a biometric authorization method for a vehicle can be implemented, which includes steps or operations such as, for example, associating a biometric authentication interface with a visor connectable to an interior cabin of a vehicle; scanning at least one biometric identifier provided by a user through at least one biometric reader of the biometric authentication interface, wherein the biometric authentication interface facilitates analysis and processing of data associated with the at least one biometric identifier for use in authorizing the user with respect to the vehicle and/or to access an electronic system associated with the vehicle.

In another example embodiment, a biometric authorization method for a rideshare application can be implemented, which includes steps or operations such as receiving at least one biometric identifier from a user through at least one biometric reader of a biometric authentication interface connected to an interior cabin of a vehicle, wherein the biometric authentication interface comprises at least one biometric reader for scanning at least one biometric identifier provided by a user and wherein the biometric authentication interface facilitates analysis and processing of data associated with the at least one biometric identifier for use in authorizing the user for rideshare trip in the vehicle and access to an electronic system associated with the vehicle during the rideshare trip; and authorizing the user for the rideshare trip and the access to the electronic system associated with the vehicle during the rideshare trip, if a biometric match is identified with respect to the user, in response to the analysis and the processing of the data associated with the at least one biometric identifier including attempting to identity the biometric match.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A biometric authorization apparatus for a vehicle, said apparatus comprising:
a visor connected to an interior cabin of a vehicle having a vehicle controller; and
a biometric authentication interface associated with said visor, wherein said biometric authentication interface comprises a sensor coupled to said vehicle controller, said sensor comprising at least one biometric reader for scanning at least one biometric identifier provided by a user, wherein said biometric authentication interface facilitates analysis and processing of data associated with said at least one biometric identifier for use in authorizing said user with respect to said vehicle and/or to access an electronic system associated with said vehicle, wherein said electronic system includes said vehicle controller.

2. The apparatus of claim 1 wherein said biometric authentication interface is integrated with said visor and said visor comprises a client device including said biometric authentication interface, and wherein said vehicle controller is associated with at least one auxiliary component, said at least one auxiliary component including a GPS (Global Positioning Satellite) communications unit for providing GPS data indicative of a location of said vehicle, wherein said GPS data is utilized in association with said data associated with said at least one biometric for said authorizing said user.

3. The apparatus of claim 1 wherein said biometric authentication interface includes a display unit that functions both as said biometric reader and as a display for graphically displaying an interactive GUI (Graphical User Interface) that displays data for said user, wherein said display unit further comprises a touchscreen display that provides said interactive GUI and wherein said interactive GUI displays said data for said user in at least two display areas of said display unit, wherein said interactive GUI graphically displays graphical icons for inputting at least one biometric identifier from said user, said display unit integrating both said interactive GUI and said biometric authentication interface.

4. The apparatus of claim 3 wherein said display unit comprises an organic light emitting diode (OLED).

5. The apparatus of claim 3 wherein said display unit comprises a flexible display.

6. The apparatus of claim 3 wherein said display unit comprises a 3D (3-dimensional) display.

7. The apparatus of claim 3 wherein said display unit comprises an e-ink display.

8. The apparatus of claim 3 wherein said display unit comprises a thin film transistor-liquid crystal display (TFT-LCD).

9. The apparatus of claim 2 wherein said vehicle comprises an autonomous vehicle and at least one biometric reader comprises an iris scanner.

10. The apparatus of claim 9 wherein said at least one biometric reader further comprises a facial recognition apparatus comprising at least one camera and wherein said apparatus further comprises a PAN (Personal Area Network) associated with said vehicle, wherein said PAN communicates wirelessly with a processor that in turn communicates with said vehicle controller and wherein said electronic system associated with said vehicle comprises said PAN.

11. The apparatus of claim 3 further comprising a PAN (Personal Area Network) associated with said vehicle, wherein said PAN communicates wirelessly with a processor that in turn communicates with said vehicle controller and wherein said electronic system associated with said vehicle includes said PAN.

12. The apparatus of claim 10 wherein said iris scanner further comprises at least one infrared light emitting diode and an IR (Infrared) camera.

13. The apparatus of claim 12 wherein said PAN comprises a PAN based on induction wireless technology and wherein said at least one biometric reader further comprises a voice recognition device.

14. The apparatus of claim 2 wherein said user comprises a driver of said vehicle and wherein said biometric authentication interface comprises a GUI (Graphical User Interface) and functions as both a touch screen user interface and a biometric sensor comprising said at least one biometric reader.

15. The apparatus of claim 10 wherein said user comprises a passenger of said vehicle and wherein said biometric authentication interface comprises a GUI (Graphical User Interface) and functions as both a touch screen user interface and a biometric sensor comprising said at least one biometric reader.

16. The apparatus of claim 11 wherein said PAN comprises an in-vehicle PAN configured as a UWB (Ultra-Wideband) network that transmits data via baseband pulses directly applied to an antenna located in said vehicle.

17. The apparatus of claim 3 wherein said biometric authentication interface facilitates said analysis and said processing of said data associated with said at least one biometric user utilizing ML (Machine Learning) for use in said authorizing said user with respect to said vehicle and/or to access said electronic system associated with said vehicle, wherein said ML learning comprising an ML learning algorithm that constructs a rule set to predict a result based on values with respect to a number of features and wherein a series of input patterns is provided to said ML learning algorithm along with a desired output.

18. A biometric authorization apparatus for a rideshare application, said apparatus comprising:
a biometric authentication interface connected to an interior cabin of a vehicle, wherein said biometric authentication interface comprises at least one biometric reader for scanning at least one biometric identifier provided by a user, wherein said biometric authentication interface facilitates analysis and processing of data associated with said at least one biometric identifier for use in authorizing said user for a rideshare trip in said vehicle and access to an electronic system associated with said vehicle during said rideshare trip, wherein said biometric authentication interface is associated with said rideshare application, wherein said rideshare application comprises a computer program downloadable to a GPS-enabled mobile device associated with said user and which runs on a processor associated with said GPS-enabled mobile device and wherein said rideshare application communicates with said biometric authentication interface and facilitates said analysis and said processing of said data associated with said at least one biometric identifier for use in said authorizing said user for said rideshare trip and wherein said rideshare application links said user to an SPO (Service Provider Organization) comprising a ride share entity.

19. A biometric authorization method for a vehicle, said method comprising:
associating a biometric authentication interface with a visor connectable to an interior cabin of a vehicle having a vehicle controller; and
scanning at least one biometric identifier provided by a user through at least one biometric reader of said biometric authentication interface, wherein said biometric authentication interface comprises a sensor coupled to said vehicle controller, said sensor comprising said at least one biometric reader for said scanning of at least one biometric identifier provided by said user, wherein said biometric authentication interface facilitates analysis and processing of data associated with said at least one biometric identifier for use in authorizing said user with respect to said vehicle and/or to access an electronic system associated with said vehicle, wherein said electronic system includes said vehicle controller.

20. The method of claim 19 wherein:
said biometric authentication interface is integrated with said visor and said visor comprises a client device including said biometric authentication interface, and wherein said vehicle controller is associated with at least one auxiliary component, said at least one auxiliary component including a GPS (Global Positioning Satellite) communications unit for providing GPS data indicative of a location of said vehicle, wherein said GPS data is utilized in association with said data associated with said at least one biometric for said authorizing said user;
wherein said biometric authentication interface includes a display unit comprising a flexible display that functions both as said biometric reader and as a display for graphically displaying an interactive GUI (Graphical User Interface) that displays data for said user, wherein said display unit further comprises a touchscreen display that provides said interactive GUI and wherein said interactive GUI displays said data for said user in at least two display areas of said display unit, wherein said interactive GUI graphically displays graphical icons for inputting at least one biometric identifier from said user, said display unit integrating both said interactive GUI and said biometric authentication interface; and
wherein said vehicle comprises a PAN (Personal Area Network) associated with said vehicle, wherein said PAN communicates wirelessly with a processor that in turn communicates with said vehicle controller and wherein said electronic system associated with said vehicle includes said PAN.
